(19) United States
(12) Patent Application Publication
(10) Pub. No.: US 2003/0131513 A1
(43) Pub. Date: Jul. 17, 2003

(54) Elastically and monolithically marginated display device

(76) Inventor: Mark Fritz Runge, Redondo Beach, CA (US)

Correspondence Address: MARK FRITZ RUNGE, # 320, 512 AVENUE G, REDONDO BEACH, CA, 90277, US

(21) Appl. No.: 10/319,184

(22) Filed: Dec. 14, 2002

Related U.S. Application Data
(60) Provisional application No. 60/341,655, filed on Dec. 17, 2001.

(51) Int. Cl. G09F 21/04

(52) U.S. Cl. 40/718; 40/700; 40/644

(57) ABSTRACT

An elastically and monolithically marginated display device and of the type having a front diaphragm, an internal seal, a display element or elements, a rear diaphragm, and a frame. The continuous single piece or monolithic frame, made of a resilient and elastic material, is stretched and released into place at the perimeter of the device. The frame relies solely on dynamic mechanical action and principles based on its design and material characteristics, a pre-engineered cross section, and predetermined elastic deformations to dynamically seal the display device rendering it suitable for potentially or inherently adverse applications or uses.

### CROSS-REFERENCE TO RELATED APPLICATIONS

This application is entitled to the benefit of Provisional Patent Application Ser. #60/341655, filed Dec. 17, 2001.

### BACKGROUND—STATEMENT AS TO RIGHTS TO INVENTIONS MADE UNDER FEDERALLY SPONSORED RESEARCH AND DEVELOPMENT

Not applicable.

1. Field of Invention

This invention relates generally to display devices, and specifically to a display device suitable for potentially or inherently adverse applications or uses.

2. Description of Prior Art

Many environments, locations, areas, applications, or uses are potentially or inherently inhospitable, not conducive, unfavorable, or adverse to elements desired for display. The need for a display device suitable for potentially or inherently adverse applications or uses is well recognized, and there exist several examples of prior art intended to meet the requirements of such applications. However, a simpler, more efficient, easily assembled, reusable solution suitable for a wider array of applications or uses is needed.

Prior art examples require the undetachable adhesive moulding or bonding of parts, adhesives, many parts, or complex or built up frame sections, alone or in any combination, for functioning, are intended for one single unexchangeable display element, and are limited in their applications or uses.

An example is Rietveld and Meijers, U.S. Pat. No. 6,022,599, Display Unit, and method for manufacturing a Display Unit, Feb. 8, 2000. This display unit is an approach to the challenges of such applications with limitations.

One limitation is the requirement of its frame and front or rear diaphragms being adhesively bonded or moulded in an undetachable manner to one another for functioning. This requires a complex, precise, multiple step, multiple element injection moulding manufacturing process to adhesively bond disparate materials. This process also limits material choices to only those with the proper thermal properties and chemical compositions.

Another limitation is an opening in the device, which prevents full protection of internal display elements from the ingress of liquids for example.

Other limitations are part replacement and cleaning of adhesively bonded parts.

Additional examples are Doll, U.S. Pat. No. 5,205,059, Display Frame and Protective Container, Apr. 27, 1993, Yesbick, U.S. Pat. No. 5,787,625, Air-Chambered, Weatherproof Picture Frame, Aug. 4, 1998, and Williams, U.S. Pat. No. 6,105,287, Outdoor Display System, Aug. 22, 2000. These require adhesive material, an adhesive gasket, and adhesive tape respectfully.

The use of adhesives of any kind limits the exchangeability of a display elements, in some cases prevents exchange altogether, and is appropriate only for one single unexchangeable display element for the lifetime of the associated display device.

The use of adhesives of any kind also limits part replacement and cleaning of adhesively bonded parts.

The use of adhesives of any kind also requires precise assembly with the risk of incorrect assembly, which would render the display device useless.

Finally, the use of adhesives of any kind risks damaging display elements themselves.

Other approaches to the challenges of potentially or inherently adverse applications or uses utilize complex well and border, locking groove, mortised groove, or tongue and groove engagements, threaded, built up, or multiple layer assemblies, many parts, registration pins, magnetic strips, or vacuum processes. Other approaches also use rigid, breakable materials.

Prior art in the field of display devices suitable for potentially or inherently adverse applications or uses has been limited in effectiveness by complexity, inefficiency, difficulty of assembly, the inability to be reused with different display elements, or limited potential applications or uses, alone or in any combination.

### SUMMARY

In accordance with the present invention, a display device, in the preferred embodiment, comprises a front diaphragm, a seal, a display element or elements, a rear diaphragm, and a stretch fit frame wherein said frame is an elastic and monolithic frame.

Said front diaphragm, seal, display element or elements, and rear diaphragm are substantially coplanar, concentric, face to face, and immediately adjacent.

The seal is sandwiched between the front diaphragm and the rear diaphragm. The display element or elements is between the front diaphragm and the rear diaphragm, and is within the interior circumferential edge of the seal. The frame has an overall configuration that is substantially doughnut, torus, or ring shaped. The frame has a modified yet substantially C shaped cross section which resembles a claw, and comprises a concave interior wall or back of throat, and a convex exterior perimeter profile with tangential sloping sills which terminate at two pincer like tips. The frame, in its final assembled position at the perimeter of said display device is along, surrounds, and engages the corporate perimeter edge or periphery of a sub assembly comprising the front diaphragm, the seal, the display element or elements, and the rear diaphragm.

Specificity of objects and advantages, elements, operation, additional or alternative embodiments, ramifications, and scope of my invention will become apparent from a consideration of the drawings and ensuing specification.

### OBJECTS AND ADVANTAGES

Accordingly, several objects and advantages of my invention are:

(a) to provide a display device suitable for potentially or inherently adverse environments, locations, or areas, or for potentially or inherently adverse applications or uses, et cetera, alone or in any combination.

(b) to provide a display device whereby a display may be created, interacted with, or maintained, et cetera, alone or in any combination, in adverse environments, during adverse activities, despite adverse occurrences, or tolerant of adverse environmental factors, et cetera, alone or in any combination.

(c) to provide a display device whereby a display, view, visual, decoration, interactive visual, interactive display, interactive visual display, or visual display, et cetera, alone or in any combination, may be displayed, created, viewed, presented, communicated, afforded, achieved, maintained, preserved, utilized, reutilized, or interacted with, et cetera, alone or in any combination, despite, around, in, among, near, within, notwithstanding, in spite of, in the proximity of, in the presence of, tolerant of, regardless of, or being unaffected by, et cetera, alone or in any combination, inhospitable, nonconducive, unfavorable, or potentially or inherently adverse, et cetera, alone or in any combination, environmental factors, conditions, potentialities, environments, factors, situations, events, or occurrences, et cetera, alone or in any combination, including, but not limited to, earthquakes, handling, mishandling, dropping, falling, breakage, air, dust, particulates, mold, liquids, water, moisture, or steam, et cetera, alone or in any combination.

(d) to provide a display device whereby potentially or inherently adverse factors including, but not limited to, minorly, mildly, moderately, gently, languidly, or indirectly invasive assaults, of relatively small intensity, by air, dust, particulates, mold, or ambient, air borne, or vaporous liquids, water, moisture, or steam, et cetera, alone or in any combination, such as may be found in a bathroom with bathing or showering facilities, for example, on said display device, containing a display element or elements, may be withstood, rendered harmless, or rendered innocuous, et cetera, alone or in any combination.

(e) to provide a display device whereby potentially or inherently adverse factors including, but not limited to, majorly, severely, heavily, strongly, vigorously, or directly invasive assaults, of relatively great intensity, by liquids or liquid water, et cetera, alone or in any combination, such as immersion, submersion, squirting or spraying from a shower head, or splashing associated with bathing or showering, et cetera, alone or in any combination, for example, on said display device, containing a display element or elements may be withstood, rendered harmless, or rendered innocuous, et cetera, alone or in any combination.

(f) to provide a display device which relies on dynamic mechanical action and principles based on design and material characteristics, a pre-engineered cross section which dynamically seals based on predetermined elastic deformations which exert dynamic sealing forces, and the overall shape of its elastic and monolithic frame for functioning, which requires no adhesives, adhesive bonds, or additional complex, precise, multiple step, multiple element, costly manufacturing processes or operations.

(g) to provide a display device which has no openings in its assembled state, and therefor provides full protection for internal display elements from the ingress of liquids for example.

(h) to provide a display device which seals itself easily, simply, and well, whose parts are limited in number, easily replaced, easily cleaned, and break resistant.

(i) to provide a display device which is straightforward, easily assembled and disassembled by hand, and allows a display element or elements to be exchanged easily and frequently.

(j) to provide a display device which utilizes a simple, elastic and monolithic frame stretched into place by hand, and requires no special tools, knowledge or effort for use.

(k) to provide a display device made of user friendly, elastic, unbreakable or break resistant materials.

(l) to provide a display device that is effective, simple, efficient, easy to assemble and disassemble by hand, reusable, and has many varied potential applications or uses.

Further objects and advantages of my invention will become apparent from a consideration of the drawings and ensuing specification.

### DRAWING FIGURES

FIG. 1 shows an exploded view of all elements of the preferred embodiment of the display device in its unassembled state. The drawing includes standard drafting symbol patterns for representing transparent and opaque surfaces. Said surfaces are merely exemplary, and the display device is not limited to those specifically indicated in the drawing.

FIG. 2 shows a sectional view of the complete preferred embodiment of the display device in its assembled state.

FIG. 3 shows a sectional view, enlarged for clarity, of a portion of the preferred embodiment of the display device in its unassembled state.

FIG. 4 shows a sectional view, enlarged for clarity, of a portion of the preferred embodiment of the display device in its partially assembled state.

FIG. 5 shows a sectional view, enlarged for clarity, of a portion of the preferred embodiment of the display device in its assembled state.

FIG. 6a shows an elevational view of a complete additional embodiment of the display device in its assembled state.

FIG. 6b shows a sectional view, enlarged for clarity, of a portion of the additional embodiment of the display device in its assembled state.

### REFERENCE NUMERALS IN DRAWINGS

10 front diaphragm

20 seal

30 display element

40 rear diaphragm

50 frame

52 back of throat

54 pincer tip

56 sill

60 sub assembly

70 seal diaphragm interface

80 pincer tip sub assembly interface

90 back of throat sub assembly interface

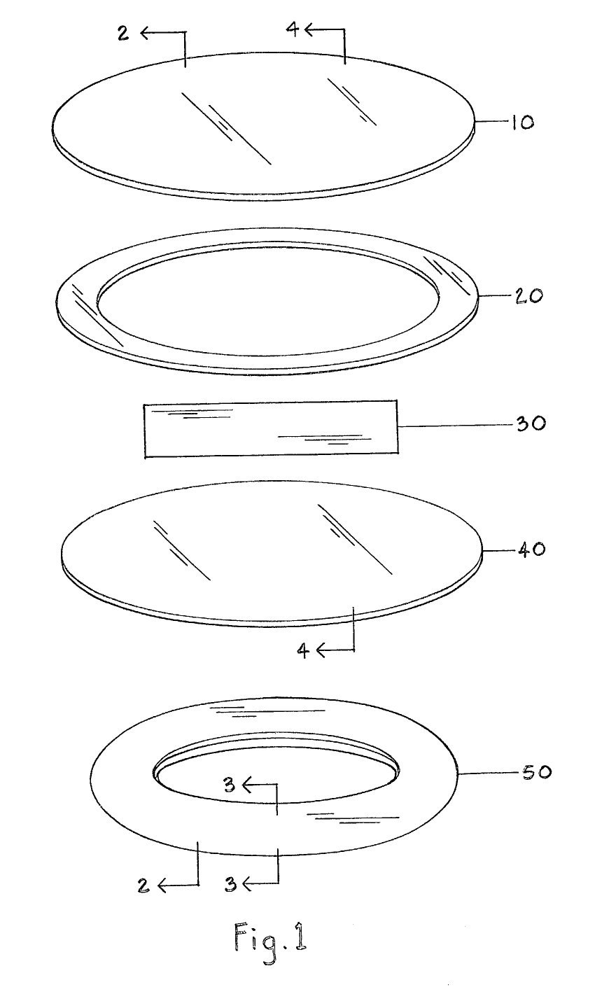

Description—FIGS. 1, 2, 3, 4, 5—Preferred Embodiment

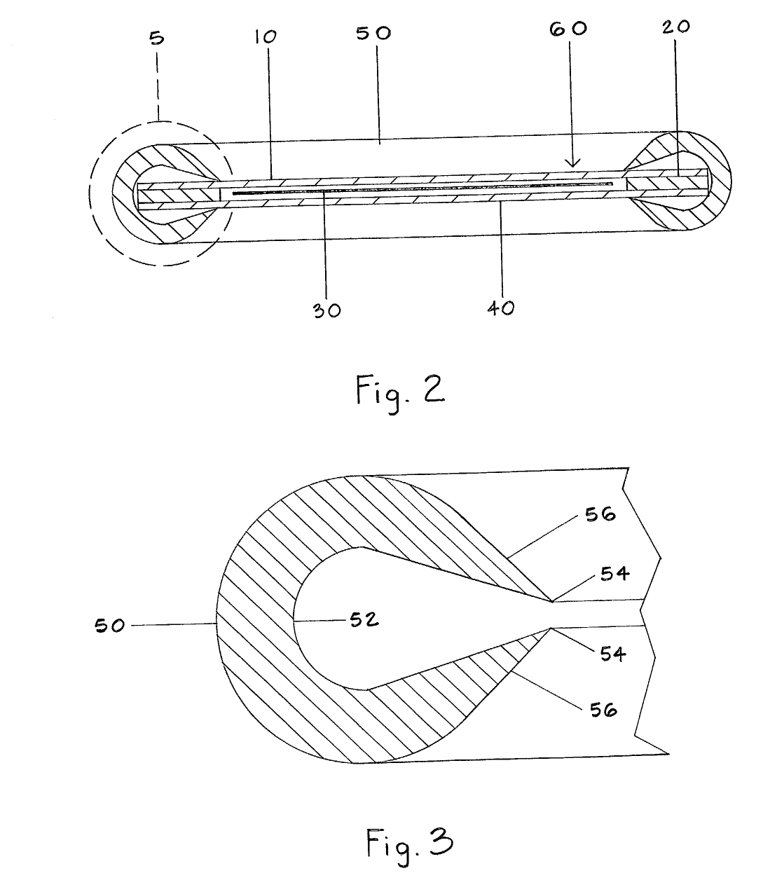

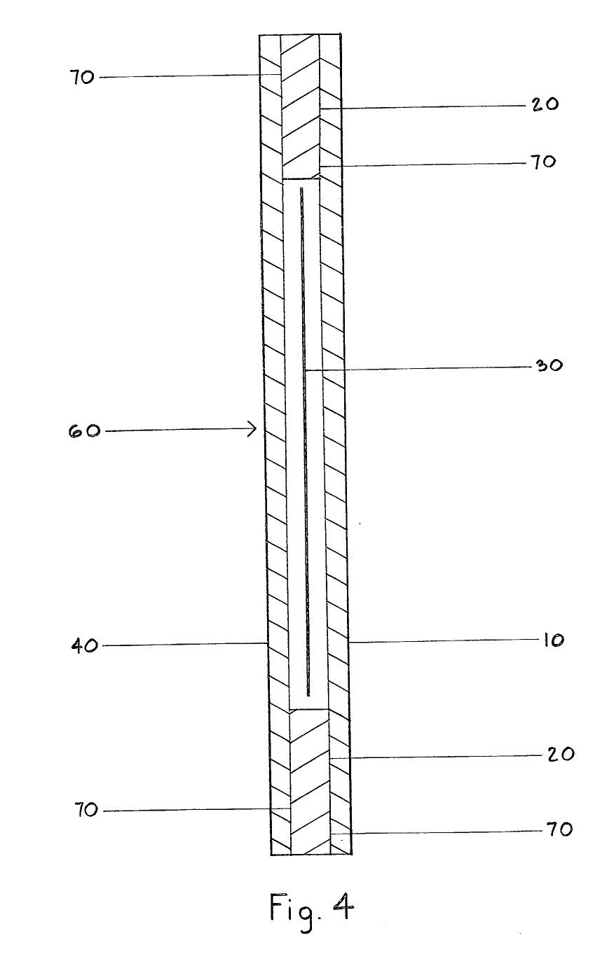

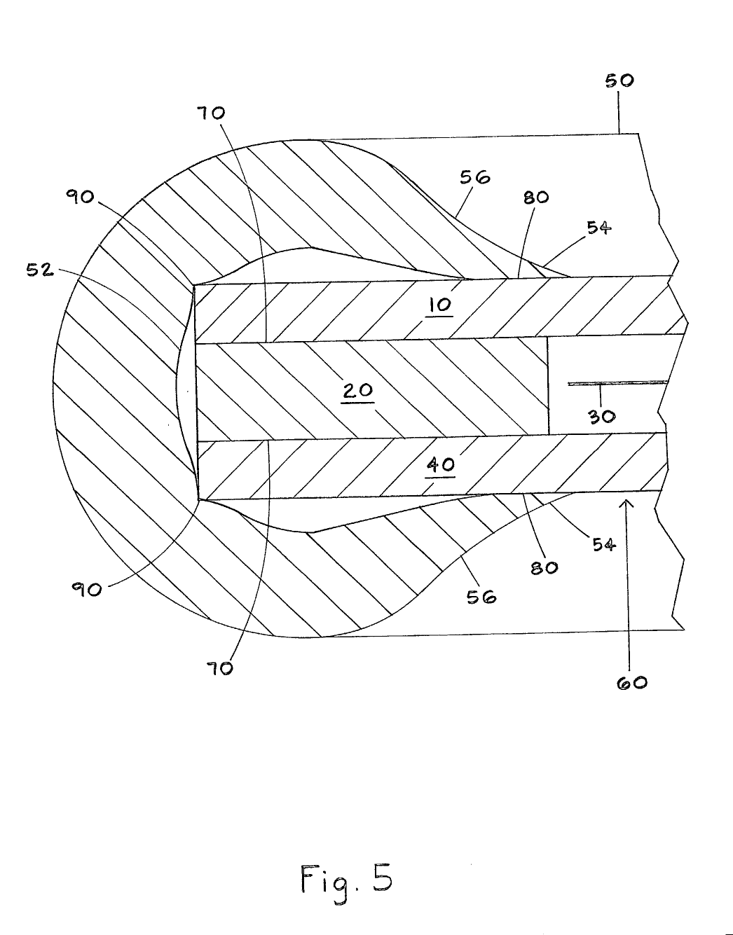

A preferred embodiment of the display device is shown in FIG. 1 (exploded view), FIG. 2 (sectional view), FIG. 3 (sectional view), FIG. 4 (sectional view), and FIG. 5 (sectional view).

The display device comprises a visually transparent or clear front disk, sheet, film, pellicle, panel, plate, or diaphragm 10, a continuous, perimeter, single piece or monolithic edging, gasket, washer, O or ring shaped seal 20, at least one viewable or visually observable, detectable, recognizable, discernable, apprehendable, sensible, or perceivable display element 30, a visually transparent or clear rear disk, sheet, film, pellicle, panel, plate, or diaphragm 40, and a continuous, perimeter, single piece or monolithic border, retainer, binding, edging, cincture, clasp, closure, encirclement, surround, banding, fastening, boundry, seal, or frame 50, as shown in FIG. 1 (exploded view) and FIG. 2 (sectional view).

In the preferred embodiment, frame 50 comprises an interior wall or back of throat 52, a claw or pincer tip 54 at two locations, and a sloped or angular shelf or sill 56 at two locations, as shown in FIG. 3 (sectional view).

In the preferred embodiment, front diaphragm 10, seal 20, display element 30, and rear diaphragm 40 are substantially coplanar, concentric, face to face, and immediately adjacent. Seal 20 is sandwiched between front diaphragm 10 and rear diaphragm 40. Display element 30 is between front diaphragm 10 and rear diaphragm 40, and within the interior circumferential edge of seal 20. A sandwiched or layered sub assembly 60 comprises front diaphragm 10, seal 20, display element 30, and rear diaphragm 40, as shown in FIG. 4 (sectional view).

Seal 20 and front diaphragm 10 interface at seal diaphragm interface 70 as shown in FIG. 5 (sectional view). Seal 20 and rear diaphragm 40 interface at seal diaphragm interface 70 as shown in FIG. 5 (sectional view).

In the preferred embodiment, frame 50 is along, surrounds, and engages the corporate perimeter edge or periphery of sub assembly 60, as shown in FIG. 2 (sectional view) and FIG. 5 (sectional view).

Back of throat 52 of Frame 50 and sub assembly 60 interface at back of throat sub assembly interface 90 as shown in FIG. 5 (sectional view).

Pincer tip 54 of frame 50 and sub assembly 60 interface at pincer tip sub assembly interface 80 as shown in FIG. 5 (sectional view).

In the preferred embodiment, both front diaphragm 10 and rear diaphragm 40 are a durable, high impact strength, impact, break, fracture, and shatter resistant, flexible, and moisture resistant plastic, such as polycarbonate—available from General Electric Company Corporation New York, One Plastics Avenue, Pittsfield, Mass. 01201 under the designation “Lexan®” polycarbonate resin sheet material and molding compound. However, the front and rear diaphragms can consist of any other similar material such as vinyl, polyvinyl chloride, acetate, polyvinyl acetate, vinyl or rubber foam, styrene, mylar, acrylic, polyethylene, polypropylene, various plasticized materials, thermoplastics, polymers, polymerized resins, resins, glass, et cetera, in the form of foam, sheet, or film, et cetera, alone or in any combination. Front diaphragm 10 and rear diaphragm 40 are both circular in shape, with similar overall perimeter circumferential diameters. However, the front and rear diaphragms can consist of any geometric or other shape. Both front diaphragm 10 and rear diaphragm 40 have a uniform cross sectional thickness, however, it may be non-uniform, variable, or dissimilar. The regions of the front diaphragm and the rear diaphragm that interface or engage seal 20 and frame 50 are smooth.

The front and rear diaphragms may be cut from sheet stock using a saw or router, cast, stamped, molded, et cetera. The edges of the front and rear diaphragms shall be smooth, deburred, eased, or otherwise free of sharp or ragged edges, if present.

In the preferred embodiment, seal 20 is a durable, flexible, yielding, pliable, compliant, compressible, resilient, elastic, and moisture resistant plastic, such as vinyl—available from South Bay Plastics of Torrance, Calif. However, the seal can consist of any other similar material such as silicone, neoprene, acetate, various elastomers, elastomerics, rubbers or rubberized materials, plastics or plasticized materials, et cetera, in the form of foam, sheet, or film, et cetera, alone or in any combination. Seal 20 is substantially ring, circle, or O shaped, with an overall, exterior or outside perimeter circumferential edge diameter similar to that of the front diaphragm and the rear diaphragm, and a concentric, interior or inside circular void. However, the seal can consist of any closed geometric or other shape. The seal has a uniform cross sectional thickness. The regions of seal 20 that interface or engage the front diaphragm and the rear diaphragm are smooth. The seal may be cut from sheet stock using a knife, cast, stamped, molded, die cut, et cetera.

In the preferred embodiment, display element 30 is a single photograph on photographic paper contained within the device. However, the display element can consist of any viewable or visually observable, detectable, recognizable, apprehendable, sensible, or perceivable element, information, communication, expression, recordation, media, material, data, object, item, et cetera, alone or in any combination, including, but not limited to the following examples; a picture, compact digital disk jewel case artwork, film, gel, cell, card, matte, image, writing, poetry, prose, lyrics, libretto, music, marking, text, message, note, list, minutes, journaling, recipe, log, quote, verse, speech, calendar, greeting card, postcard, award, name, numeral, equation, formula, figure, symbol, puzzle, crossword puzzle, dot to dot puzzle, word game, writing game, drawing game, drawing, sketch, painting, illustration, representation, optical illusion, optical phenomenon, hologram, composition, art, artwork, graphic, decoration, design, concept, idea, thought, diagram, map, survey, sign, advertising, fundraising, marketing, or promotional material, corporate incentive, emergency information, emergency escape diagram, learning aid, indicia, et cetera, alone or in any combination.

In the preferred embodiment, the display element may be any independent object or objects, such as a compact disk, food, liquid, dried or pressed flower, tree leaf, seashell, sand, coral, butterfly, picture postcard, page of sheet music, menu, crossword puzzle cut from a newspaper, painting on canvas, stained glass, colored paper, vinyl, sheet vinyl, vinyl foam, collage, mosaic, relief, puzzle, applique, sheet magnet, magnets, magnetic game boards, magnetic game pieces, various image, picture, or text carriers being sheet or film like, et cetera, or communication conveying elements, et cetera, alone or in any combination. The display element may be any media or deposited substance, such as ink, toner, pen, pencil, grease pencil, crayon, marker, paint, et cetera, alone or in any combination, applied mechanically or with any technique, instrument, device, or machine, et cetera, such as writing, marking, sketching, doodling, figuring, composing, calculating, notating, transcribing, silk-screening, airbrushing, photography, imaging, et cetera, alone or in any combination, to the display device.

Display element 30 may be preprinted, user defined, permanent, permanently affixed, semi-permanent, semi-permanently affixed, erasable, removable, removable with a mild abrasive or polish, reusable, detachable, exchangeable, replaceable, water soluble, water resistant, water proof, et cetera, alone or in any combination.

Application of the display element to the device may be achieved by molding, imprinting, texturing, embossing, tooling, frosting, deposition, et cetera, alone or any combination. Application of the display element to the device may be achieved using a subtractive, or removal technique, such as etching, abrading, sand blasting, lasing, carving, or scratching, et cetera, alone or in any combination.

Finally, display element 30 may be any visually perceivable element, as described or otherwise, for a single or multiple purpose, for one time or multiple time use, consist of any media or material, as described or otherwise, be applied, affixed, adhered, fastened, taped, glued, or bonded to, on, deposited on, or contained within, et cetera, alone or in any combination, the sealed interior of the display device, be applied, affixed, adhered, fastened, taped, glued, or bonded to, on, or deposited on, et cetera, alone or in any combination, the obverse or reverse of front diaphragm 10, be applied, affixed, adhered, fastened, taped, glued, or bonded to, on, or deposited on, et cetera, alone or in any combination, the obverse or reverse of rear diaphragm 40, be on, applied, affixed, adhered, fastened, taped, glued, bonded, deposited, et cetera, to the exterior of the display device, alone or in any combination or multiple.

In the preferred embodiment, frame 50 is a durable, flexible, yielding, pliable, compliant, compressible, resilient, elastic, and moisture resistant rubber, such as silicone or polysiloxane—available from General Electric Company Corporation New York, 260 Hudson River Road, Waterford, N.Y. 12188 under the designation “LIM®6040” liquid silicone rubber. However, the frame can consist of any other material such as vinyl, vinyl foam, neoprene, various elastomers, elastomerics, rubbers or rubberized materials, et cetera, alone or in any combination. The frame, in the preferred embodiment, has a hardness of approximately 40 durometer shore A, but may be otherwise. The overall configuration of frame 50 is substantially doughnut, torus, or ring shaped, with a concentric, interior or inside circular void, as shown in FIG. 1 (exploded view). However, the frame can consist of any closed geometric or other shape.

In the preferred embodiment, frame 50 has a modified yet substantially claw, pincer, or C shaped cross section, with a wall thickness that tapers down at sill 56 in two locations, to pincer tip 54 at two locations, which extends toward the centroid of the display device, as shown in FIG. 3 (sectional view). The opening of the cross section of frame 50 between each pincer tip 54 is oriented toward the centroid of the display device. Prior to its final assembled position at the perimeter of the display device, and in its relaxed or unstretched state, frame 50 is dimensionally smaller than the overall thickness dimension of sub assembly 60, at this opening. As shown in FIG. 5 (sectional view) this dimensional difference is sufficient to provide a close mating engagement at each pincer tip sub assembly interface 80 around the entire periphery of the display device, when frame 50 and sub assembly 60 are in assembled relation.

In the preferred embodiment, prior to its final assembled position at the perimeter of the display device, and in its relaxed or unstretched state, frame 50 is dimensionally smaller than the overall circular perimeter circumferential diameter dimension of sub assembly 60, in its back of throat 52 to back of throat 52 diameter dimension. As shown in FIG. 5 (sectional view) this dimensional difference is sufficient to provide a close mating engagement at each back of throat sub assembly interface 90 around the entire periphery of the display device, when frame 50 and sub assembly 60 are in assembled relation.

The regions of frame 50 that interface or engage front diaphragm 10, rear diaphragm 40, and sub assembly 60, are smooth.

Frame 50 is a single piece, monolithic, or unitary structure which may be formed by liquid injection molding, compression or heat transfer molding, casting, or any other standard manufacturing technique or process being used today for similar items.

The display device is preferably made of materials that can be economically and efficiently manufactured, present an attractive appearance, and maintain a pleasing and durable structure for an indefinite period of time, and multiple use.

While a specific embodiment of the display device has been illustrated and described, it is to be understood that this embodiment is provided by way of example only, and that the display device is not to be construed as being limited thereto.

Operation—FIGS. 2, 3, 4, 5—Preferred Embodiment

The functions of each of the constituent parts of a preferred embodiment of the display device act together to enable easy assembly and disassembly, and facilitate the successful operation, utilization, and reutilization of the display device, in showering, bathing, wet, dry, indoor, or outdoor environments, or during wet, dry, or underwater activities, alone or in any combination.

Operation of the display device is as a display, viewing, presentation, or recordation means, alone or in any combination, for display element 30, in all its permutations, alone or any combination. The display device allows display element 30 to be displayed, viewed, presented, recorded, et cetera, or interacted with, when the display device acts as a recordation means for an additional display element 30, alone or any combination. Display element 30, when enclosed or contained within the sealed interior of the display device, as shown in FIG. 2 (sectional view), FIG. 4 (sectional view), and FIG. 5 (sectional view), is protected by the display device against damage from, or the ingress of potentially or inherently adverse or undesirable foreign material or environmental factors, alone or in any combination, as required. These factors may include air, dust, particulates, liquids, water, moisture, or steam, et cetera, alone or in any combination.

The primary function of front diaphragm 10 is to provide visual access or facilitate viewing of display element 30. The front diaphragm protects display element 30, when said display element is contained within the sealed interior of the device, as shown in FIG. 2 (sectional view), FIG. 4 (sectional view), and FIG. 5 (sectional view), against damage from, or the ingress of, potentially or inherently adverse or undesirable foreign material or environmental factors, alone or in any combination, as required. These factors may include air, dust, particulates, liquids, water, moisture, or steam, et cetera, alone or in any combination. The front diaphragm, being made of a flexible, durable, high impact strength, impact, break, fracture, and shatter resistant material protects users from possible accidents such as falling, dropping, or breakage, et cetera. The front diaphragm provides a tablet, pad, pallet, slate, surface, or substrate means for display element 30, when said display element is applied to the device. Finally, front diaphragm 10 may perform any single one, or any combination of these functions.

The primary function of seal 20 is to provide a first deterrent or mechanical barrier to the ingress of, or damage from,, potentially or inherently adverse or undesirable foreign material or environmental factors, alone or in any combination, into the display device, at each seal diaphragm interface 70, as shown in FIG. 5 (sectional view), as required. The smooth surfaces of seal 20 closely align and create a mated engagement with the smooth surfaces of front diaphragm 10 and rear diaphragm 40, and form this first deterrent. Seal 20 exerts sufficient attractive force to retain the front and rear diaphragms by the surface tension present between their face to face, smooth surface to smooth surface mated engagement. Seal 20 acts as a shim or spacer, providing a dimensional separation between the front diaphragm and the rear diaphragm. This separation has two positively influential effects, on the device. The first is to accommodate the thickness of display element 30, when contained within the sealed interior of the device. The second is to increase or enforce the effectiveness of a second deterrent or mechanical barrier to the ingress of, or damage from, potentially or inherently adverse or undesirable foreign material or environmental factors, alone or in any combination, into the display device, as required, by increasing pressure against frame 50, at pincer tip 54, in two locations, perpendicular to the major plane of the display device, along pincer tip sub assembly interface 80, in two locations, as shown in FIG. 5 (sectional view), around the entire periphery of the display device. Finally, seal 20 may perform any single one, or any combination of these functions.

The primary function of display element 30 is to personalize, enhance, improve, et cetera, or add utility, or communication, expression, or recordation capability to, showering, bathing, wet, dry, indoor, outdoor environments, or wet or underwater activities, alone or in any combination, and is easily exchangeable. A photograph contained within the display device, as the display element, provides personalized visual relief to a wet confined space with blank walls, such as a shower, for example. Writing a note on the device, as the display element, allows communication between housemates with different schedules, in a bathroom, for example. Recording responsive solutions on the display device as a first display element 30, while visually referencing an unsolved crossword puzzle clipped from a newspaper as a second display element 30, contained within the device, in the shower, or elsewhere in the home, is also an example. Display element 30, when applied to the display device using permanent media such as indelible ink, for example, is unaffected by water, but can be removed from the display device using a mild abrasive such as toothpaste, or an eraser. Display element 30 may be viewed through the front diaphragm, the rear diaphragm, or both. Finally, display element 30 may perform any single one, or any combination of these functions.

The primary function of rear diaphragm 40 is to protect display element 30, when said display element is contained within the sealed interior of the device, as shown in FIG. 2 (sectional view), FIG. 4 (sectional view), and FIG. 5 (sectional view), from the ingress of, or damage from, potentially or inherently adverse or undesirable foreign material or environmental factors, alone or in any combination, as required. The rear diaphragm provides visual access or facilitates viewing of display element 30. The rear diaphragm, being made of a flexible, durable, high impact strength, impact, break, fracture, and shatter resistant material protects users from possible accidents such as falling, dropping, or breakage, et cetera. The rear diaphragm provides a tablet, pad, pallet, slate, surface, or substrate means for display element 30, when said display element is applied to the device. Finally, rear diaphragm 40 may perform any single one, or any combination of these functions.

The primary function of frame 50 is to releasably, stably, and snugly secure, retain, restrain, border, bind, edge, encircle, clasp, surround, seal, band, fasten, compress, or frame all other elements of the device in their assembled relation. The frame protects said parts from damage or the ingress of potentially or inherently adverse or undesirable foreign material or environmental factors, alone or in any combination, as required. The frame, being made of a flexible, yielding, compliant, compressible, resilient, and elastic material also protects users from the edges of sub assembly 60, or possible accidents such as dropping, or breakage, et cetera, alone or in any combination.

In the preferred embodiment, prior to its final assembled position at the perimeter of the display device, and in its relaxed or unstretched state, frame 50 is dimensionally smaller in its back of throat 52 to back of throat 52 diameter dimension than the overall circular perimeter circumferential diameter dimension of sub assembly 60. As shown in FIG. 5 (sectional view) this dimensional difference is sufficient to provide a close mating engagement at each back of throat sub assembly interface 90 around the entire periphery of the display device, when frame 50 and sub assembly 60 are in assembled relation. Back of throat 52 of frame 50, in its final assembled position and stretched configuration, at the perimeter of the display device, compressing or contracting toward the centroid of the display device and against the exterior corporate perimeter circumferential edges of sub assembly 60, compresses, yields or deforms slightly, and allows partial intrusion of said edges into frame 50 at back of throat 52 forming a mated or engaged, contact or union, or mechanical interlock, as shown in FIG. 5 (sectional view). Back of throat 52 also conforms securely, snugly, or tightly with said edges of sub assembly 60 to increase or enforce the effectiveness of a third deterrent or mechanical barrier to the ingress of, or damage from, potentially or inherently adverse or undesirable foreign material or environmental factors, alone or in any combination, at back of throat sub assembly interface 90, as shown in FIG. 5 (sectional view), as required. The smooth surface of frame 50, at back of throat 52, very closely aligns and creates a mated engagement with the smooth edges of sub assembly 60, and forms this third deterrent or mechanical barrier at back of throat sub assembly interface 90, as shown in FIG. 5 (sectional view).

In the preferred embodiment, prior to its final assembled position at the perimeter of the display device, and in its relaxed or unstretched state, frame 50 is dimensionally smaller at the opening between each pincer tip 54 than the overall thickness dimension of sub assembly 60. Each pincer tip 54 of frame 50, in its final assembled position and stretched configuration, at the perimeter of the display device, compresses or contracts toward and against the exterior faces of sub assembly 60, and perpendicularly to the major plane of the display device, and clamps or clasps the exterior faces of sub assembly 60, as shown in FIG. 5 (sectional view). Each pincer tip 54 compresses, yields or deforms slightly, and conforms securely, snugly, or tightly with said faces of sub assembly 60 forming a mated or engaged contact or union to increase or enforce the effectiveness of the second deterrent or mechanical barrier to the ingress of unwanted or undesirable foreign material or environmental factors at pincer tip sub assembly interface 80, as shown in FIG. 5 (sectional view), as required. The smooth surface of frame 50, at each pincer tip 54, very closely aligns and creates a mated engagement with the smooth surfaces of sub assembly 60, and forms this second deterrent or mechanical barrier at pincer tip sub assembly interface 80, as shown in FIG. 5 (sectional view).

In the preferred embodiment, prior to its final assembled position at the perimeter of the display device, and in its relaxed or unstretched state, frame 50 is dimensionally smaller at the opening between each pincer tip 54 than the overall thickness dimension of sub assembly 60. Each sill 56 of frame 50, in its final assembled position and stretched configuration, at the perimeter of the display device, compresses or contracts toward the exterior faces of sub assembly 60, perpendicular to the major plane of the display device, compresses, deforms slightly, slopes, and provides a fourth deterrent or mechanical barrier to the ingress of unwanted or undesirable foreign material or environmental factors, as shown in FIG. 5 (sectional view), as required. The slope of each sill 56 induces or directs such factors to shed, sheet, flow, or cascade to the exterior of the assembled device, as required.

Frame 50 exerts sufficient forces to retain and immobilize sub assembly 60 in a steady state.

Frame 50 masks seal 20 from view.

Frame 50 provides a visual frame or border for display element 30.

Finally, frame 50 may perform any single one, or any combination of these functions.

The manner of using the display device as a display, viewing, presentation, or recordation means, alone or in any combination, for display element 30, in all its permutations, alone or in any combination, includes assembly of the constituent elements, utilization, and disassembly. This sequence may be repeated.

Assembly of the display device is simple, and requires no tools, special knowledge, or effort, and can be effected in about one minute. All elements are to be clean and otherwise free from dirt, oil, lint, moisture, et cetera. First, front diaphragm 10 placed front or exterior face down, flat on a clean, flat, and horizontal working surface. Seal 20 is then placed on the back or interior face of front diaphragm 10. The exterior perimeter circumferential edge of seal 20 is aligned with the exterior perimeter circumferential edge of the front diaphragm. Display element 30 is then placed face down on the back or interior face of front diaphragm 10, and within the interior circumferential edge of seal 20. Rear diaphragm 40 is then placed on seal 20. The exterior perimeter circumferential edge of the rear diaphragm is aligned with the exterior perimeter circumferential edge of seal 20. The resulting sub assembly 60 is then pinched by hand along its perimeter to form a close mating engagement, referred to above as the first deterrent or mechanical barrier to the ingress of unwanted or undesirable foreign material or environmental factors into the display device, at each seal diaphragm interface 70. Finally, in a single simple operation, frame 50 is dilated or stretched open to accommodate or receive sub assembly 60, released, and allowed to contract or constrict, rest finally and snugly against, and releasibly secure, retain, compress, border, bind, encircle, surround, band, fasten, bound, closely mechanically engage, or seal the corporate perimeter or peripheral edge of sub assembly 60. The substantially C shaped cross section of frame 50 as shown in FIG. 3 (sectional view), is configured to receive, accommodate, and provide a close mating engagement with sub assembly 60. Frame 50 remains in this detachably secured state as shown in FIG. 2 (sectional view) and FIG. 5 (sectional view), until removed.

The display device, assembled as described, is functionally operational as a means for the display, viewing, presentation, recordation of, or interaction with, alone or in any combination, display element 30, in all its permutations, alone or in any combination, to personalize, enhance, improve, et cetera, or add utility, or communication, expression, or recordation capability to, showering, bathing, bathroom, wet, dry, indoor, outdoor environments, or underwater, wet, or adverse activities, alone or in any combination.

The display device may be utilized for viewing, displaying, presenting, or otherwise visually referencing or interacting with, et cetera, alone or in any combination, or recording, writing, inscribing, marking, or otherwise physically interacting with, et cetera, alone or in any combination, at least one display element 30. An example of utilization for viewing is as a picture frame, in the shower, bath, bathroom, or elsewhere in the home. An example of utilization for recording is as a note or sketch pad, or marking, writing or drawing slate or tablet, in the shower, bath, bathroom, or elsewhere in the home.

The device may be utilized in a combined fashion for non-simultaneous viewing and recording of any number of layered, stratified, or superimposed display elements, independently relative to each other. An example of this is writing a grocery list on the display device, with a marking instrument, as a first display element 30, and not at that moment visually referencing a picture of the ocean, as a second display element 30, contained within the display device, for decorative purposes at other times, in the shower, bath, bathroom, or elsewhere in the home.

The device may be utilized in a combined fashion for simultaneous viewing and recording of any number of layered, stratified, or superimposed display elements, dependently relative to each other. An example of this is recording responsive solutions on the display device, with a marking instrument, as a first display element 30, while visually referencing an unsolved crossword puzzle clipped from a newspaper, as a second display element 30, contained within the display device, in the shower, bath, bathroom, or elsewhere in the home. A noteworthy benefit of this example is that the recording of responsive solutions is non-destructive, or the original second display element 30 is not marked in any way, and may be utilized at another time, by another individual, or both.

Utilization of the display device may include the exchange, addition, removal, or revision, et cetera, alone or in any combination, of display element 30, or routine maintenance. The device may be added to shower or bath walls, shower doors, mirrors, refrigerators, windows, boats, et cetera, or may otherwise be utilized in shower, bath, bathroom, sink, jacuzzi, hot tub, sauna, marine or garden areas, et cetera, alone or in any combination. Generally the device may be used in, but is not limited to, showering, bathing, wet, dry, indoor, or outdoor environments, or during potentially or inherently adverse, wet, dry, or underwater activities, et cetera, alone or in any combination.

Disassembly of the device is simple, requires no tools, and can be effected in less than one minute. First, frame 50 is dilated or stretched open to release sub assembly 60. Front diaphragm 10 is separated from seal 20. Display element 30 is removed. Finally, seal 20 is separated from rear diaphragm 40. After disassembly, and if previously contained within the display device, display element 30 may be replaced, exchanged, added, removed, revised, et cetera, alone or in any combination. After disassembly all elements may be easily cleaned for routine maintenance, with soap and warm water. Display element 30, if previously applied to the display device using permanent media such as indelible ink, for example, can be removed, erased, or eradicated, or revised using a mild abrasive such as toothpaste, or an eraser. The display device may easily be reused multiple times after assembly, utilization, and disassembly of the constituent elements. The display device may be fastened by any conventional means to a rigid or supporting member or structure, such as a shower door, a shower or bath wall, wall, mirror, refrigerator, window, or the like.

The display device may be used in industry, commercially, or for personal use, et cetera, alone or in any combination.

The display device may be used for reviewing, memorizing, informing, or learning from the display element, alone or in any combination. An example of this is following instructions for breast self-examination for cancer, in the shower. Another example is the display of a fire-exiting diagram and instructions, in a hotel or cruise ship shower or bathroom.

The display device may or may not provide full or partial protection against damage or the ingress of unwanted or undesirable foreign material or environmental factors, alone or in any combination, as required.

The display device may be used inside aquariums, terrariums, or cages.

The display device may be used by sailors, boaters, kayakers, white water rafters, canoers, hikers, backpackers, alpine skiers, cross country skiers, off roaders, et cetera.

The display device may be used as a clipboard.

The display device may be used as a storage container, box or case.

The device may be used as a writing, drawing, or marking tablet for use with exchangeable visual references.

The display device, sized appropriately, may be used as a candle or drink coaster.

The device may be used to protect the display element from falling or earthquake damage.

The display device may be used as a greeting card or award. Any text, greeting, or message, personalized or otherwise, may be erased or removed by the recipient, and the additionally enclosed display element 30, or any other display element 30 may be displayed as artwork, for example.

The display device may be for single, multiple, or combination purposes or uses.

The display device may be reused.

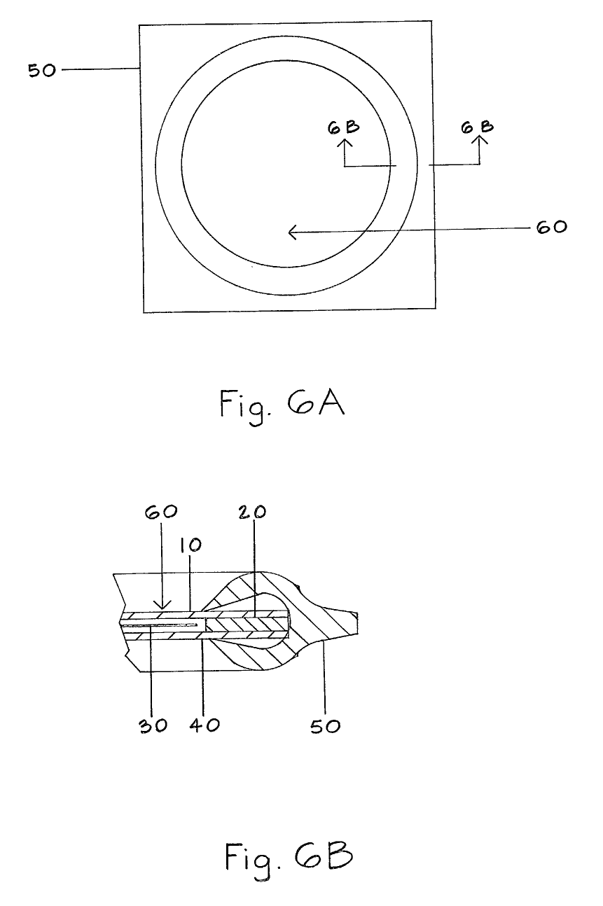

Additional Embodiment—FIG. 6a, 6b

Description

In an additional embodiment, including all elements as described in the preferred embodiment, frame 50 may further include a faceted overall perimeter composed entirely of multiple radially configured straight edges, as shown in FIG. 6a (elevational view). Said frame may be molded to further include an external portion of its cross sectional profile appropriate for use as a squeegee, as shown in FIG. 6b (sectional view). Said edges may be of similar, differing, or a combination of lengths, and may not necessarily be along the entire perimeter of the display device.

Operation

Operation of the additional embodiment, as described immediately above, would be similar to the operation of the preferred embodiment. Additionally, the additional embodiment could be swiped across any surface to remove unwanted or excess moisture.

Conclusion, Ramification, and Scope

Thus the reader will see that the display device of this invention can be used and reused to easily and conveniently enhance, personalize or decorate, and add utility or function to wet environments in particular and other areas in general.

While the above description contains many specificities, these should not be construed as limitations on the scope of the display device, but rather as merely an exemplification or illustration of one preferred embodiment, and one additional embodiment thereof. Following are listed some examples of possible variations or ramifications of the display device.

Front diaphragm 10 may be eliminated.

Front diaphragm 10 may have any number of voids or apertures.

Additional front diaphragms may be added.

Front diaphragm 10, rear diaphragm 40, or both may be other materials such as metal, paper, contact paper, sheet vinyl, sheet magnet, sheet vinyl laminated sheet magnet, vinyl foam, vinyl foam laminated sheet magnet, wood, glass, et cetera, alone or in any combination.

Two display devices, each with rear diaphragm 40 made of a magnetic material, may be placed on either side of a glass door or window, and require no additional attachment means. Seal 20 may be eliminated.

Seal 20 may have any number of voids or apertures.

Additional seals may be added.

Seal 20 may be intermittent or discontinuous.

Seal 20 may have no center void or aperture and be substantially disk, plate, sheet, or diaphragm like.

Seal 20 may be an o-ring.

The thickness of seal 20 may be increased or decreased to accommodate the thickness of display element 30.

Display element 30 may be eliminated.

Display element 30 may have any number of voids or apertures.

Additional display elements may be added.

Display element 30 may be a sealed assembly.

Display element 30 may be on, between, within, outside, or any combination, one or more seal 20.

An additional display element or elements may be temporarily or permanently affixed to the display element, any other element, elements, or the display device itself, alone or any combination.

Display element 30 may be water-resistant or waterproof, and other elements of the display device may not require sealing or moisture resistant properties or characteristics, or be required at all.

Display element 30 may be sealed against the front diaphragm, the rear diaphragm, the seal, or anywhere in between, alone or in any combination.

Resistance to damage and the ingress of unwanted or undesirable foreign material or environmental factors, such as moisture, dust, et cetera, or any combination of such factors may be further improved by independently sealing display element 30 prior to installation in the display device.

Rear diaphragm 40 may be eliminated.

Rear diaphragm 40 may have any number of voids or apertures.

Additional rear diaphragms may be added.

Frame 50 may be eliminated.

Additional frames may be added.

Frame 50 may have any number of voids or apertures.

Frame 50 may be intermittent or discontinuous.

Frame 50 may have an overall exterior shape different from its interior shape or the front or rear diaphragms, or the seal or seals it may contain.

Frame 50 may have an intended oversized perimeter flange to be cut to any desired shape by any user of the display device.

Frame 50 may be permanently attached.

Any element, elements, or the display device itself, may vary in degrees of opacity or clarity, be clear, transparent, semitransparent, translucent, opaque, white, black, or any shade or color, or any combination.

Any element, elements, or the display device itself, may incorporate, have integral, be molded with or as, or be designed to accommodate permanent, detachable, or exchangeable dispensers, reservoirs, or receptacles for bar soap, liquid soap, bath beads, bath salts, hand lotion, bubble bath, body lotion, shampoo, hair conditioner, skin conditioner, hair treatment, perfume, cologne, lotion, oil, shave cream, after shave, deodorant, deodorizers, cleansers, toothpaste, writing or drawing devices, mouthwash, dental floss, denture cream, aroma therapy agents, et cetera, alone or in any combination. The addition of such, to the display device, is anticipated and considered obvious.

Any element, elements, or the display device itself, may incorporate, have integral, be molded with or as, or be designed to accommodate permanent, detachable, or exchangeable holders, clips, ports, pins, registration pins, shelves, or hooks for additional display elements or display devices, wash cloths, towels, toothbrushes, cups, cleaning brushes or sponges, back or bath brushes or sponges, sponges, razors, dentures, nail brushes, files, or clippers, toys, jewelry, decorations, glasses, candles, tools, sundries, utilities, tear off or removable marking media, marking devices or instruments, et cetera, alone or in any combination. The addition of such, to the display device, is anticipated and considered obvious.

Any element, elements, or the display device itself may incorporate, have integral, be molded with or as, or be designed to accommodate permanent, detachable, or exchangeable devices, accessories, implements, or apparatus such as a squeegees, tooth brushes, cleaning brushes or sponges, bathing brushes or sponges, razors, handles, clocks, timers, thermometers, barometers, radios, bath pillows, candles, scents, deodorizers, ionizers, computers, liquid crystal displays, light emitting diode displays, calculators, marking devices or instruments, televisions, recorders, compact digital disc players or recorders, digital video disc players, digital recorders, MP3 players or recorders, phones, baby monitors, mirrors, lenses, tools, back massagers, massagers, electrical, chemical, mechanical, or photo, et cetera illumination, lighting, or light producing devices, et cetera, alone or in any combination. The addition of such, to the display device, is anticipated and considered obvious.

For fastening, mounting, attaching, hanging, or affixing the display device to or resting it on various surfaces, any element, elements, or the display device itself, may incorporate, have integral, be molded with or as, or be designed to accommodate permanent, detachable, or exchangeable attachment means, rests, or devices such as double suction cups, suction cups, lines, laces, cords, goose necks, stands, standoffs, feet, bases, clasps, catches, shelves, apertures, hooks, clasps, engagements, matings, hangers, handles, magnets, sheet magnets, hook and loop fasteners, tape, adhesive, adhesive or tacky clays, foams, plastics, vinyls, sheet vinyls, vinyl foams, or rubbers, et cetera, alone or in any combination. The addition of such, to the display device, is anticipated and considered obvious.

Any element, elements, or the display device itself, may be made of a material, or configured to create a suction effect, at some portion of its exterior, and require no additional apparatus for mounting on various surfaces.

Any element, elements, or the display device itself, may be made of a material, or configured to create sufficient surface adhesion, at some portion of its exterior, and require no additional apparatus for mounting on various surfaces.

Any element, elements, or the display device itself, may incorporate, have integral, be molded with or as, or be designed to accommodate permanent, detachable, or exchangeable magnifying or any other type of lens, alone or in any combination. The addition of such, to the display device, is anticipated and considered obvious.

Any element, elements, or the display device itself may incorporate locators, guides, registration pins, steps, ridges, profiles, or edge treatments, et cetera, alone or in any combination, to aid in proper assembly or increase ease of assembly, or the security of their mating.

Any element of the display device may be attached to any other element.

Any element or elements of the display device may be partially or wholly integrated with any other element or elements, in any combination.

Any element or elements of the display device may be made up of separate parts.

Characteristics, functions, or both of individual elements may be exchanged. For example, the front and rear diaphragms may be made of vinyl, as described in the preferred embodiment as the material for the seal, and the seal may be made of polycarbonate, as described in the preferred embodiment as the material for the front and rear diaphragms.

One single display device may contain more than one display aperture.

The display device may be reused with a different display element 30.

The display device or any of its elements may be any shape or size.

The display device or any of its elements may be any material.

Elements of the display device may be connected or associated with adjacent elements in a different manner than described in previous embodiments.

Elements of the display device may be given a different mode or function of operation than described in previous embodiments.

The display device may have different interior shapes, exterior shapes, or both.

The display device may be permanently sealed.

The device may incorporate a hinge or hinges.

Several display devices may be linked or otherwise connected.

The addition or incorporation of permanent, detachable, or exchangeable edging, rings, collars, profiles, decoration, relief, sculptural elements, attached or applied detail, et cetera, to any element, elements, or the display device itself, is anticipated and considered obvious. Such additions may be achieved by molding, imprinting, texturing, abrading, embossing, tooling, frosting, deposition, lasing, or carving, et cetera, alone or any combination, in an additive or subtractive manner.

The addition or incorporation of sealants, adhesives, barriers, sprays or applications, et cetera, to elements, the exterior, or the interior of the display device is anticipated and considered obvious.

Finally, the display device may comprise any element or use described in the preferred, additional, or any other embodiment incorporating the implied spirit of the display device, or ramification, alone or in any combination, and while the device has been described with specificity, modifications may be made without departing from the spirit of the device, and no limitations are to be inferred.

Many other variations are possible, and the scope of the invention should not solely be determined by the embodiments illustrated, examples given, or variations listed.

I claim:

1. A display device comprising:
a front disk, sheet, film, pellicle, panel, plate, or diaphragm, said front diaphragm being visually transparent, durable, and having a uniform cross section
a viewable or visually observable, detectable, recognizable, apprehendable, sensible, discernable, or perceivable display element or elements, said display element being substantially two dimensional with an overall perimeter shape equal to or less than the overall perimeter shape of said front diaphragm
a continuous, resilient, elastic, single piece or monolithic, perimeter or boundary edging, binding, banding, border, retainer, closure, fastening, surround, encirclement, clasp, cincture, seal, or frame, said frame having an overall perimeter shape that is closed, similar to the overall perimeter shape of said front diaphragm, said frame also having an interior void about the centroid of the frame, and a modified, yet substantially c shaped cross section, the opening of which is directed toward the centroid of the frame
said front diaphragm and said display element being substantially coplanar, concentric, face to face, and immediately adjacent
said frame being dilated, along, surrounding, and closely engaging the outermost perimeter edge or periphery of said front diaphragm
whereby a display may be created, interacted with, or maintained, alone or in any combination, in adverse environments, during adverse activities, despite adverse occurrences, or tolerant of adverse environmental factors, alone or in any combination.

2. The display device of claim 1, further including:
a rear disk, sheet, film, pellicle, panel, plate, or diaphragm, said rear diaphragm being substantially the same overall perimeter shape and dimensions of said front diaphragm, visually transparent, durable, and having a uniform cross section
said rear diaphragm being substantially coplanar, face to face, and immediately adjacent to said display element
said display element being sandwiched between said front diaphragm and said rear diaphragm
said rear diaphragm being substantially coplanar, concentric, and aligned with the overall periphery of said front diaphragm
said frame being further dilated, along, surrounding, and closely engaging the outermost perimeter edge or periphery of said rear diaphragm additionally.

3. The display device of claim 2, further including:
a continuous, elastic, single piece or monolithic, gasket, washer, o or ring shaped seal, said seal having an overall perimeter shape that is closed, similar to the overall perimeter shape of said front and rear diaphragms, having an interior void about the centroid of the seal, and a uniform cross section
said seal being substantially coplanar, concentric, face to face, immediately adjacent, and aligned with the overall periphery of said front and rear diaphragms
said seal being sandwiched between said front diaphragm and said rear diaphragm
said display element being within the interior void of said seal.

4. Method for creating a display device, which display device comprises a front disk, sheet, film, pellicle, panel, plate, or diaphragm, said front diaphragm being visually transparent, durable, and having a uniform cross section, and a viewable or visually observable, detectable, recognizable, apprehendable, sensible, discernable, or perceivable display element or elements, said display element being substantially two dimensional with an overall perimeter shape equal to or less than the overall perimeter shape of said front diaphragm, situated essentially parallel to the front diaphragm, and a continuous, resilient, elastic, single piece or monolithic, perimeter or boundary edging, binding, banding, border, retainer, closure, fastening, surround, encirclement, clasp, cincture, seal, or frame, said frame having an overall perimeter shape that is closed, similar to the overall perimeter shape of said front diaphragm, said frame also having an interior void about the centroid of the frame, and a modified, yet substantially c shaped cross section, the opening of which is directed toward the centroid of the frame, and which holds the front diaphragm, wherein said front diaphragm and said display element are placed substantially coplanar, concentric, face to face, and immediately adjacent, and in that subsequently in a stretching process said frame is dilated to admit said front diaphragm, and allowed to contract along, surrounding, and closely engaging the outermost perimeter edge or periphery of said front diaphragm, whereby a display may be created, interacted with, or maintained, alone or in any combination, in adverse environments, during adverse activities, despite adverse occurrences, or tolerant of adverse environmental factors, alone or in any combination.

5. Method according to claim 4, further including a rear disk, sheet, film, pellicle, panel, plate, or diaphragm, situated essentially parallel to said display element and said front diaphragm, said rear diaphragm being substantially the same overall perimeter shape and dimensions of said front diaphragm, visually transparent, durable, and having a uniform cross section, wherein said rear diaphragm is placed substantially coplanar, face to face, and immediately adjacent to said display element, said display element being sandwiched between said front diaphragm and said rear diaphragm, wherein said rear diaphragm and said front diaphragm are placed substantially coplanar, concentric, and aligned, and in that subsequently in an additional stretching process said frame is dilated to additionally admit said rear diaphragm, and allowed to additionally hold, contract along, surround, and closely engage the outermost perimeter edge or periphery of said rear diaphragm.

6. Method according to claim 5, further including a continuous, elastic, single piece or monolithic, gasket, washer, o or ring shaped seal, said seal having an overall perimeter shape that is closed, similar to the overall perimeter shape of said front and rear diaphragms, having an interior void about the centroid of the seal, and a uniform cross section, situated essentially parallel to said front diaphragm, said display element, and said rear diaphragm, wherein said seal is placed substantially coplanar, concentric, face to face, immediately adjacent, and aligned with the overall periphery of said front and rear diaphragms, wherein said seal is placed sandwiched between said front diaphragm and said rear diaphragm, said display element being within the interior void of said seal.
